(19) United States
(12) Patent Application Publication
(10) Pub. No.: US 2015/0193521 A1
(43) Pub. Date: Jul. 9, 2015

(54) Methods for Generating an Activity Stream

(71) Applicant: GOOGLE INC., Mountain View, CA (US)

(72) Inventors: Eric Benson Schoeffler, Boulder, CO (US); Ian Gunn, Potts Point (AU); George York, Lyons, CO (US); Michael Jeffrey Procopio, Boulder, CO (US)

(73) Assignee: GOOGLE INC., Mountain View, CA (US)

(21) Appl. No.: 14/151,054

(22) Filed: Jan. 9, 2014

(51) Int. Cl. G06F 17/30

(52) U.S. Cl. CPC G06F 17/30598

(57) ABSTRACT

A method includes storing, at one or more computing devices, a plurality of activity information items each describing an action taken and including a plurality of parameter values each corresponding to one of a plurality of parameter types. The method also includes identifying a filtering metric that corresponds to a specified value for a first parameter type, and generating a filtered set of activity information items that match the specified value. The method also includes identifying a grouping metric that corresponds to a second parameter type from the plurality of parameter types, identifying one or more groups of the filtered activity information items each corresponding to a unique parameter value for the second parameter type. The method also includes outputting, for display, an activity stream including information that represents each activity information item from the filtered set of activity information items arranged according to the one or more groups.

### BACKGROUND

The disclosure herein relates generally to reshaping object activity for display.

Computer systems are known that allow for shared access to objects. As one example, shared storage systems allow users to create or store objects such as files at a remote server, access the files via a network such as the internet, grant shared access to the files to other users, and in some examples, edit the file using a file creation and editing system that is associated with the shared storage system. As another example, a calendar application can allow a user to create a calendar object and grant shared access to the calendar objects to other users. As another example, a task management application can allow creation of task objects for assigning tasks to other users, thus granting the other users shared access to the task object. Shared access to an object by a second user can include any or all of the ability to view the object, modify the object, share the object with additional users, make copies of the object, and delete the object. These types of systems are referred to herein as shared access systems. Shared access systems can allow actions to be taken with respect to an object. As an example, online document storage and editing systems are known that store files and allow multiple users who have been granted access to a particular file to take actions such as viewing and editing the file.

### SUMMARY

The disclosure relates to methods for generating an activity stream.

One aspect of the disclosed embodiments is a method that includes storing, at one or more computing devices, a plurality of activity information items, each activity information item describing an action taken with respect to a respective object from a plurality of objects that are stored at a shared access system, and each activity information item including a plurality of parameter values each corresponding to one of a plurality of parameter types. The method also includes identifying a filtering metric, wherein the filtering metric corresponds to a specified value for a first parameter type from the plurality of parameter types, and generating a filtered set of activity information items that match the specified value for the first parameter type. The method also includes identifying a grouping metric, wherein the grouping metric corresponds to a second parameter type from the plurality of parameter types, identifying one or more groups of activity information items from the filtered set of activity information items, wherein each group from the one or more groups corresponds to a unique parameter value for the second parameter type, and outputting, for display, an activity stream including information that represents each activity information item from the filtered set of activity information items arranged according to the one or more groups.

Another aspect of the disclosed embodiments is a non-transitory computer-readable storage device including program instructions executable by one or more processors that, when executed, cause the one or more processors to perform operations. The operations include storing a plurality of activity information items, each activity information item describing an action taken with respect to a respective object from a plurality of objects that are stored at a shared access system, and each activity information item including a plurality of parameter values each corresponding to one of a plurality of parameter types. The operations also include identifying a filtering metric, wherein the filtering metric corresponds to a specified value for a first parameter type from the plurality of parameter types. The operations also include generating a filtered set of activity information items that match the specified value for the first parameter type. The operations also include identifying a grouping metric, wherein the grouping metric corresponds to a second parameter type from the plurality of parameter types. The operations also include identifying one or more groups of activity information items from the filtered set of activity information items, wherein each group from the one or more groups corresponds to a unique parameter value for the second parameter type. The operations also include outputting, for display, an activity stream including information that represents each activity information item from the filtered set of activity information items arranged according to the one or more groups.

Another aspect of the disclosed embodiments is an apparatus that includes one or more processors; and one or more memory devices for storing program instructions used by the one or more processors. The program instructions, when executed by the one or more processors, cause the one or more processors to store a plurality of activity information items, each activity information item describing an action taken with respect to a respective object from a plurality of objects that are stored at a shared access system, and each activity information item including a plurality of parameter values each corresponding to one of a plurality of parameter types. The program instructions further cause the one or more processors to identify a filtering metric, wherein the filtering metric corresponds to a specified value for a first parameter type from the plurality of parameter types, and generate a filtered set of activity information items that match the specified value for the first parameter type. The program instructions further cause the one or more processors to identify a grouping metric, wherein the grouping metric corresponds to a second parameter type from the plurality of parameter types, and identify one or more groups of activity information items from the filtered set of activity information items, wherein each group from the one or more groups corresponds to a unique parameter value for the second parameter type. The program instructions further cause the one or more processors to output, for display, an activity stream including information that represents each activity information item from the filtered set of activity information items arranged according to the one or more groups.

### BRIEF DESCRIPTION OF THE DRAWINGS

The description herein makes reference to the accompanying drawings wherein like reference numerals refer to like parts throughout the several views, and wherein:

FIG. 1 is a block diagram showing an example of an environment in which a system for generating an activity stream can be implemented;

FIG. 2 is a block diagram showing an example of a hardware configuration for a server computer;

FIG. 3 is a block diagram showing a plurality of shared access systems and an activity service;

FIG. 4 is a block diagram showing operation of an activity stream generator;

FIG. 5 is a flowchart showing an example of a process for generating an activity stream;

FIG. 6 is an illustration showing an interface screen for a storage system including an activity stream according to a first example;

FIG. 7 is an illustration showing an activity stream according to a second example;

FIG. 8 is an illustration showing an activity stream according to a third example; and

FIG. 9 is an illustration showing an activity stream according to a fourth example.

### DETAILED DESCRIPTION

In some shared access systems, a large number of actions can be performed by a group of users in a short time span. As examples, these actions can include moving files, sharing files, deleting files, and editing files. The shared access system can record information describing these actions, and output that information for display to each user in the form of an activity stream. However, including information describing every action that occurs within an activity stream can be overwhelming to users and thus render the activity stream useless. The methods and systems described herein allow users to change the way that events are displayed in the activity stream, which may be referred to herein as “reshaping” the activity stream, based on information associated with the events described by the activity stream. Thus, where a user is interested in certain types of actions or remembers some details of an action that the user wants to find, the user can leverage that information to reshape the information that is included in the activity stream, thereby making it more relevant and useful to the user.

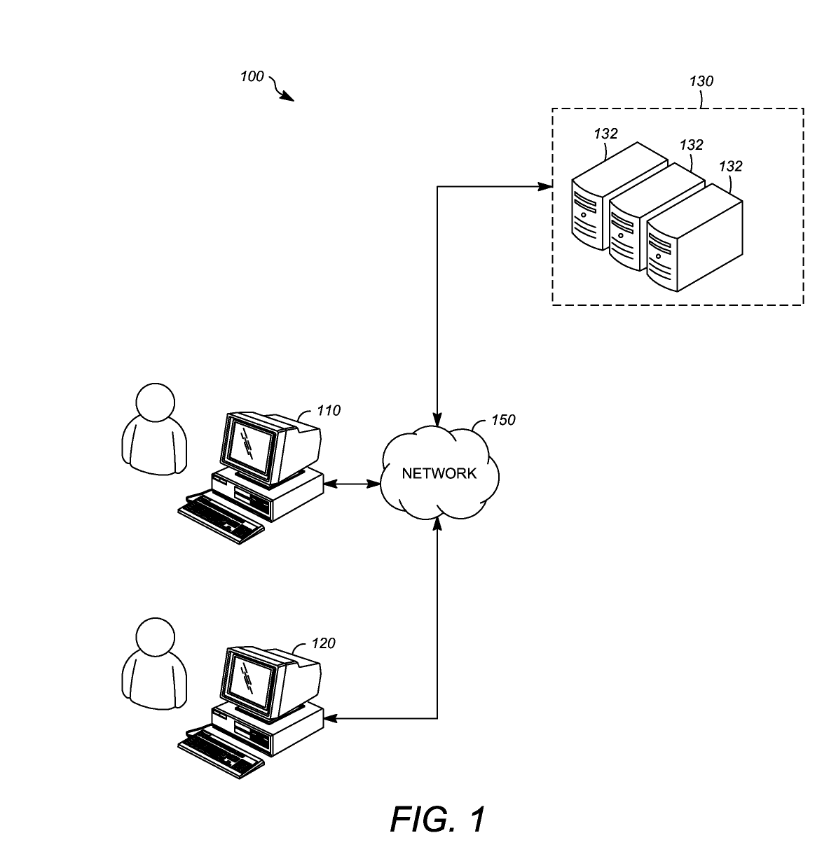

FIG. 1 shows an example of an environment 100 in which a system for generating an activity stream can be implemented. The environment 100 can include a user system 110, one or more additional user systems 120, and an application hosting service 130. The user system 110 and the additional user systems 120 are each representative of a large number (e.g. millions) of systems that can be included in the environment 100, with each system being able to utilize one or more applications that are provided by the application hosting service 130. The user system 110 and the additional user systems 120 can each be any manner of computer or computing device, such as a desktop computer, a laptop computer, a tablet computer, or a smart-phone (a computationally-enabled mobile telephone). The application hosting service 130 can be implemented using one or more server computers 132. The user system 110, the additional user systems 120, and the application hosting service 130 can each be implemented as a single system, multiple systems, distributed systems, or in any other form.

The systems, services, servers, and other computing devices described here are in communication via a network 150. The network 150 can be one or more communications networks of any suitable type in any combination, including wireless networks, wired networks, local area networks, wide area networks, cellular data networks, and the internet.

The application hosting service 130 can implement a shared access system that provides access to one or more hosted applications to a defined group of users including operators associated with the user system 110 and the additional user systems 120. As used here, a shared access system is any manner of system, program, or interface that allows a defined group of users to utilize an access-restricted system in which information can be shared between users for the purpose of working collaboratively. As will be discussed below, shared access systems can implement document storage, creation, and editing functions. In some implementations, the application hosting service 130 allows access to certain objects upon presentation of a credential, such as a username and password combination, where the user identified by the credential is authorized to access the objects by virtue of ownership of the objects or by virtue of a grant of access by the owner of the object. In some implementations, one or more users are able to grant access to specific objects to additional users or revoke access from existing users. Objects can be, as examples, files, containers (e.g. folders), documents, images, and/or collections of data in any form.

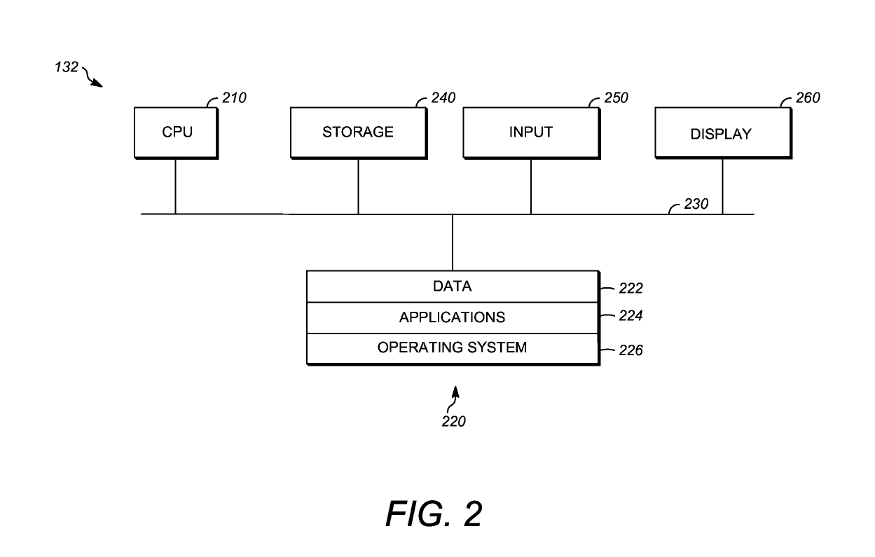

FIG. 2 is a block diagram of an example of a hardware configuration for the one or more server computers 132 of FIG. 1. The same hardware configuration or a similar hardware configuration can be used to implement the user system 110 and the additional user systems 120. Each server computer 132 can include a CPU 210. The CPU 210 can be a conventional central processing unit. Alternatively, the CPU 210 can be any other type of device, or multiple devices, capable of manipulating or processing information now-existing or hereafter developed. Although the disclosed examples can be practiced with a single processor as shown, e.g. CPU 210, advantages in speed and efficiency can be achieved using more than one processor.

Each server computer 132 can include memory 220, such as a random access memory device (RAM). Any other suitable type of storage device can also be used as the memory 220. The memory 220 can include code and data 222 that can be accessed by the CPU 210 using a bus 230. The memory 220 can further include one or more application programs 224 and an operating system 226. The application programs 224 can include software components in the form of computer executable program instructions that cause the CPU 210 to perform the operations and methods described here.

A storage device 240 can be optionally provided in the form of any suitable computer readable medium, such as a hard disc drive, a memory device, a flash drive, or an optical drive. One or more input devices 250, such as a keyboard, a mouse, or a gesture sensitive input device, receive user inputs and can output signals or data indicative of the user inputs to the CPU 210. One or more output devices can be provided, such as a display device 260. The display device 260, such as a liquid crystal display (LCD) or a cathode-ray tube (CRT), allows output to be presented to a user, for example, in response to receiving a video signal.

Although FIG. 2 depicts the CPU 210 and the memory 220 of each server computer 132 as being integrated into a single unit, other configurations can be utilized. The operations of the CPU 210 can be distributed across multiple machines (each machine having one or more of processors) which can be coupled directly or across a local area or other network. The memory 220 can be distributed across multiple machines such as network-based memory or memory in multiple machines. Although depicted here as a single bus, the bus 230 of each of each server computer 132 can be composed of multiple buses. Further, the storage device 240 can be directly coupled to the other components of the respective server computer 132 or can be accessed via a network and can comprise a single integrated unit such as a memory card or multiple units such as multiple memory cards. The one or more server computers can thus be implemented in a wide variety of configurations.

FIG. 3 is a block diagram showing a plurality of shared access systems that are in communication with an activity service 300. In the illustrated example, the shared access systems include a storage system 330 and an editing system 320. The storage system 330 and the editing system 320 are examples of systems that can be in communication with the activity service 300. It should be understood, however, that different or additional systems could be utilized in conjunction with the activity service 300. Each of these systems and services can be, for example, provided in the form of software instructions that are executed by a processor or computer, such as the one or more server computers 132 of the application hosting service 130.

The storage system 330 is operable to provide a remotely accessible interface by which users can store files, access those files, and share those files with other users. The storage system 330 can provide access via, for example, a web based interface that can be output for display in the context of a web browser at a client device, such as the user system 110. The editing system 320 is a network accessible system that allows for the creation and editing of documents. The editing system 320 can, in some implementations, be utilized in conjunction with the storage system 330 to obtain documents from the storage system 330 and to store documents at the storage system 330. In some implementations, the editing system 320 is accessible via a web browser based interface that can be output for display at a client device, such as 2 at the user system 110.

The activity service 300 is operable to receive information from shared access services describing actions taken with respect to objects at the shared access services. The information that is received by the activity service 300 can be stored in the form of activity information items 310, which are stored at the activity service 300 or are stored such that they are accessible to the activity service 300. For example, the activity service 300 can be implemented by the application hosting service 130, and the activity information items 310 can be stored at storage devices that are associated with and managed by the application hosting service 130. The activity information items 310 can include information describing, for example, an identity of an object, an action taken with respect to that object, the identities of one or more users associated with the action, information related to the time at which the action occurred, and information identifying one or more systems that were involved executing the action with respect to the object. Information is considered to be included in an activity information item when it is explicitly incorporated in the item, is referred to by the activity information item, or can be looked up, inferred or determined from the information included in an activity information item. The activity information items 310 can be stored in any suitable form. As one example, the activity information items can be stored as database objects in a database.

Each activity information item can a plurality of parameter values that each correspond to a parameter type. Parameters values describe characteristics of the object or the action taken with respect to the object. Examples of parameter types include an object identity parameter type, a user identity parameter type, an object location parameter type, an object class parameter type, and an event class parameter type. The activity information items can include other types of information regarding the object or the action, such as the time at which the action occurred.

Parameter values for the object identifier parameter type include information that identifies a particular object or a group of objects. The parameter value for the object identifier parameter type can be any manner of information with by which an objected can be identified, such as for the purpose of retrieving the object from a storage device. Thus, a unique identifier could be assigned to an object, and that identifier could be encoded as a parameter value for any activity information item that relates to that object.

Several other parameter values can relate to the object that is described by or that relates to an activity information item, such as an object location parameter type, an object class parameter type. In some implementations, these are explicitly included in the activity information item. In other implementations, these are included in the activity information item implicitly, as they can be looked up based on the object identifier. Parameter values for the object location parameter type include information describing one or more locations where the object is located, such as in a folder, document collection, or other organizational construct. Parameter values for the object class parameter type can include information that classifies similar objects together based on criteria file type or file format. Example parameter values for the object class parameter type can identify an object as, for example, a word processing document, a spreadsheet, a movie, or an audio file. P

Parameter values for the user identity parameter type include information that corresponds to a user or a group of users. For example, the user identity parameter type can include information that corresponds to the user or group of users that caused performance of the action described by an activity information item.

Parameter values for the application identity parameter type can identify an application that is related to an activity information item or which caused an activity information item to be created. For example, when an activity information item relates to edits made to a word processing document, the parameter value for the application identity parameter type can identify the word processing application.

Parameter values for the event class parameter type include information describing the action taken with respect to the object. Examples of actions that can be described by parameter values for the event class parameter type include moving an object, removing an object, deleting an object, archiving an object, renaming an object, sharing an object, unsharing an object, joining a group, leaving a group, restoring an object, uploading an object, creating an object, adding an object to a location or collection, versioning an object, copying an object, editing an object, modifying an object, posting a status, accessing an object or location, subscribing to information such as information relating to an object or location, or information describing any other type of action.

In some implementations, the activity service 300 may include an activity interface 302. In some implementations, the activity interface 302 may be an activity interface server. In some implementations, the activity interface 302 may provide an application programming interface for the activity service 300. In some implementations, the activity interface 302 may receive queries related to the activity information items and may process the queries.

In some implementations, the activity service 300 may include an activity manager 304. In some implementations, the activity manager 304 may receive activity notifications from, for example, the storage system 330 or the editing system 320. In some implementations, the activity manager 304 may process the activity notifications and may generate the activity information items 310.

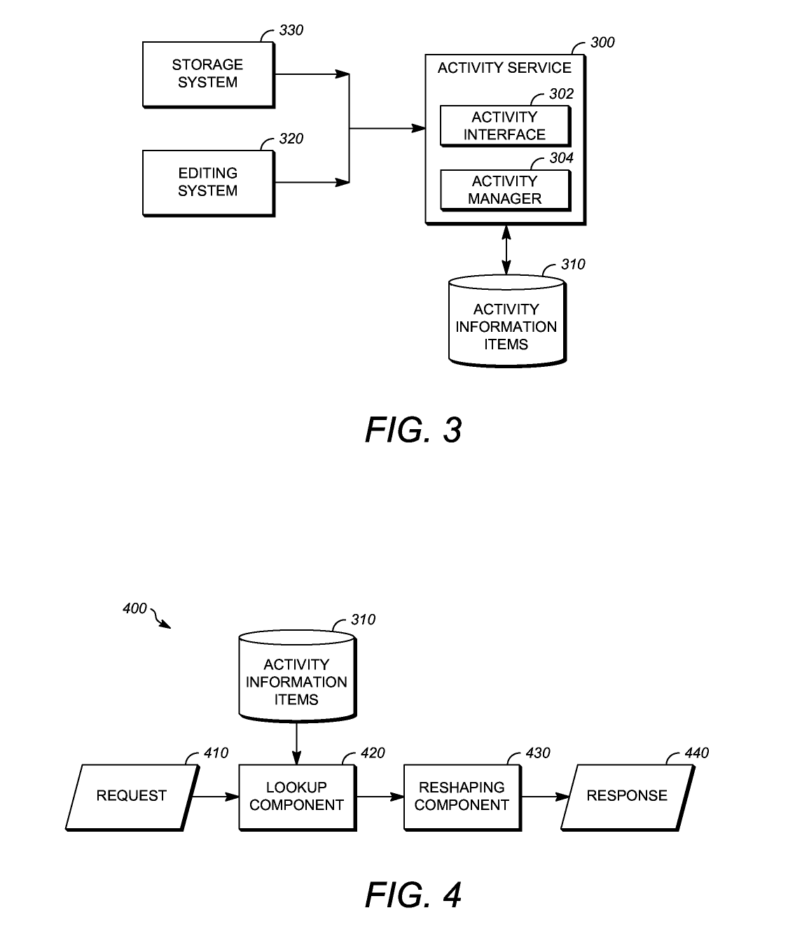

The activity information items 310 can be utilized to provide insight to users as to the actions that have been taken with respect to one or more objects. This can information can be provided to users in a meaningful format using a system or service such as an activity stream generator 400, as shown in FIG. 4. An activity information request 410 is received as an input at a look-up component 420 of the activity stream generator 400. The activity information request 410 can originate from a user. For example, the activity information request 410 can be received at the application hosting service 130 from the user system 110 via the network 150. The activity information request 410 relates to one or more objects. As one example, the activity information request 410 can specify one or more objects to which the activity information request 410 relates. As another example, the request can include information for identifying one or more objects to which the activity information request 410 relates. The look-up component 420 receives the activity information request 410, and identifies one or more activity information items 310 that match the activity information request 410. Information relating to activity information items 310, such as identifying information or the items themselves, is passed from the look-up component 420 to a reshaping component 430.

The reshaping component 430 is operable to receive the activity information items 310 associated with the object indicated by the activity information request 410 from the lookup component 420, to generate an activity stream by reshaping the activity information items 310, and to output the activity stream for presentation as a response 440 to the request 410.

In some implementations, reshaping the activity information items 310 may include filtering the activity information items 310 to exclude one or more activity information items 310 from a filtered set of activity information items that is used to generate the activity stream. In some implementations, one or more activity information items 310 may be omitted from the activity stream based on the user, the object, the activity information item, the activity information request 410, or a combination thereof. This can be done, for example, based on the parameter value for a specified parameter type for each of the activity information items 310, as will be explained further herein.

In some implementations, reshaping the activity information items also includes organizing information in the activity stream by grouping the activity information items 310 from the filtered set. This can be done, for example, by grouping activity information items together based on a selected parameter type as a grouping metric, and grouping together those activity information items having matching or similar values for the selected parameter type, as will be explained further herein. In addition, multiple similar activity information items 310 can be combined together into a single item of information that is included in the activity stream. For example, if there are multiple activity information items that relate to a single user editing a single document multiple times within a period of time (e.g. one day), those could be combined with each other, and then grouped with other items of information in the activity stream that reflect edits made to that document by other users or by the same user at a different time.

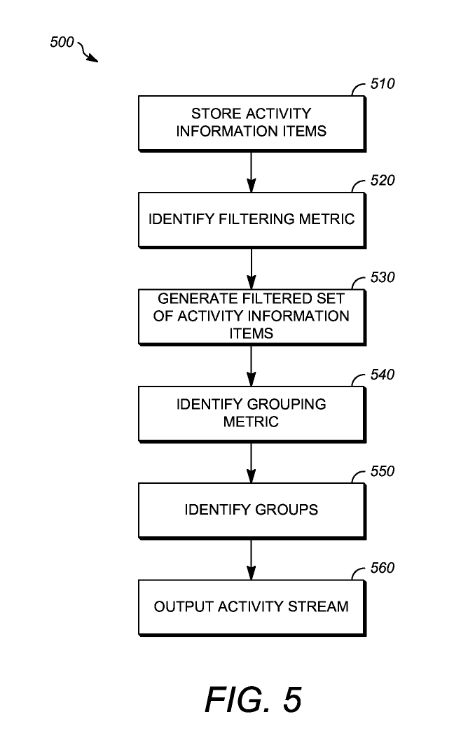

FIG. 5 is a flow chart showing a process 500 for generating an activity stream. The operations described in connection with the process 500 can be performed at one or more computers, such as at the one or more server computers 132 of the application hosting service 130. When an operation is performed by one or more computers, it is completed when it is performed by one computer. The operations described in connection with the process 500 can be embodied as a non-transitory computer readable storage medium including program instructions executable by one or more processors that, when executed, cause the one or more processors to perform the operations. For example, the operations described in connection with the process 500 could be stored at the memory 220 of one of the server computers 132 and be executable by the CPU 210 thereof.

At operation 510 activity information items are stored. In particular, a plurality of information items can be stored, each describing an action that was taken with respect to an object, such as an object that is stored at a shared access system. The activity information items can be as described previously with respect to the activity information items 310. Storage of activity information items can be performed, for example, in the manner described in connection with the activity service 300, such as by storing the activity information items as objects in a database.

Subsequent to storage of the plurality of activity information items, an activity stream is generated. The activity stream can be generated, for example, responsive to a user request for the activity stream or a user interface screen that includes the activity stream. The request can originate locally or at a remote computing device, such as a client computing device in a client-server implementation. The following operations can be performed, for example, in the manner as described with respect to the activity stream generator 400.

At operation 520 a filtering metric is identified. The filtering metric corresponds to a specified value for a first parameter type from the plurality of parameter types. In one example, the filtering metric is identified based on a default value. In another example, the filtering metric is identified based on an input signal that is received from a user. In another example, where the activity stream is to be displayed in the context of an interface screen, the filtering metric can be based on information associated with contextual information associated with the interface screen. For example, in a shared storage system, the parameter type can be a location parameter type and the specified value can be the current location (e.g. folder) represented by the current view of the interface screen. In another example, in a shared workspace that allows collaboration among members of a team, a current view of an interface screen for the team can be associated with a user identity parameter type having as its value the identities of all of the members of the team. In another example, a current view of a user interface screen for a document editing system can be associated with an object identity parameter having as its value the identity of the currently open document.

Operation 530 includes generating a filtered set of activity information items that match the specified value for the first parameter type. Generating the filtered set of activity information items can include applying the filtering metric that was identified at operation 550 to exclude some activity information items from the filtered set. In one implementation, activity information items are excluded if they do not match the filtering metric, based on one or more of the parameter values associated with each activity information item. In another implementation, activity information items are excluded based on a similarity, such as a threshold value for similarity between the filtering metric and one or more of the parameter values associated with each activity information item. Thus, filtering the activity information items can include omitting from the filtered set of activity information items one or more of the activity information items, or a portion of one or more of the activity information items, based on the filtering metric identified at operation 530. It is expressly contemplated that generating the filtered set of activity information items includes applying additional filtering metrics or strategies. For instance, in addition to excluding activity information items based on the first filtering metric, the filtered set of activity information items can be generated by also filtering some of the activity information items based on access control information. Thus, for example, the filtered set of activity information items can also exclude activity information items that refer to objects that the current user does not have access to.

Operation 540 includes identifying a grouping metric. The grouping metric can correspond to a second parameter type from the plurality of parameter types, but does not correspond to a specific value, as groups will subsequently be defined for activity information items having the same value or similar values. As examples, the grouping metric can be identified based on at least one of a default value, an input signal received from a user, or information associated with a current view, as similarly described with respect to the filtering metric. In one implementation, the grouping metric can be identified based on an input signal received via a user-operable input control that is output for display with the activity stream. In this implementation, the activity stream can be initially output without grouping or with grouping based on a default value, and the activity stream can be updated based on the user input made via the user-operable input control.

Operation 550 includes identifying one or more groups of activity information items from the filtered set of activity information items, wherein each group from the one or more groups corresponds to a unique parameter value for the second parameter type. The unique parameter can be a parameter value that all activity information items within the group match or are similar to, such as by a percentage, threshold, or probability.

Operation 560 includes outputting, for display, the activity stream. The activity stream includes information that represents each activity information item from the filtered set of activity information items arranged according to the one or more groups. The activity stream can be output for display by outputting information that is operable to cause display of the activity stream when interpreted. Thus, the activity stream can be output for display in the form of information generated by one or more server computers such as the server computers 132 of the application hosting service, and subsequently transmitted to a client device such as the user system 110 where the information is interpreted, thereby causing the activity stream to be displayed at a display device. Thus, presenting the activity stream may include rendering and displaying the activity stream as a portion of an interface, such as an interface within the context of a web browser by way of a web page, which may be encoded in a mark-up language such as HTML, and may be received at a device, such as the user system 110 shown in FIG. 1, from another device, such as the application hosting service 130 shown in FIG. 1, and may be output for display at the user system 110. In some implementations, the activity stream can be presented in a different type of application, such as a standalone application.

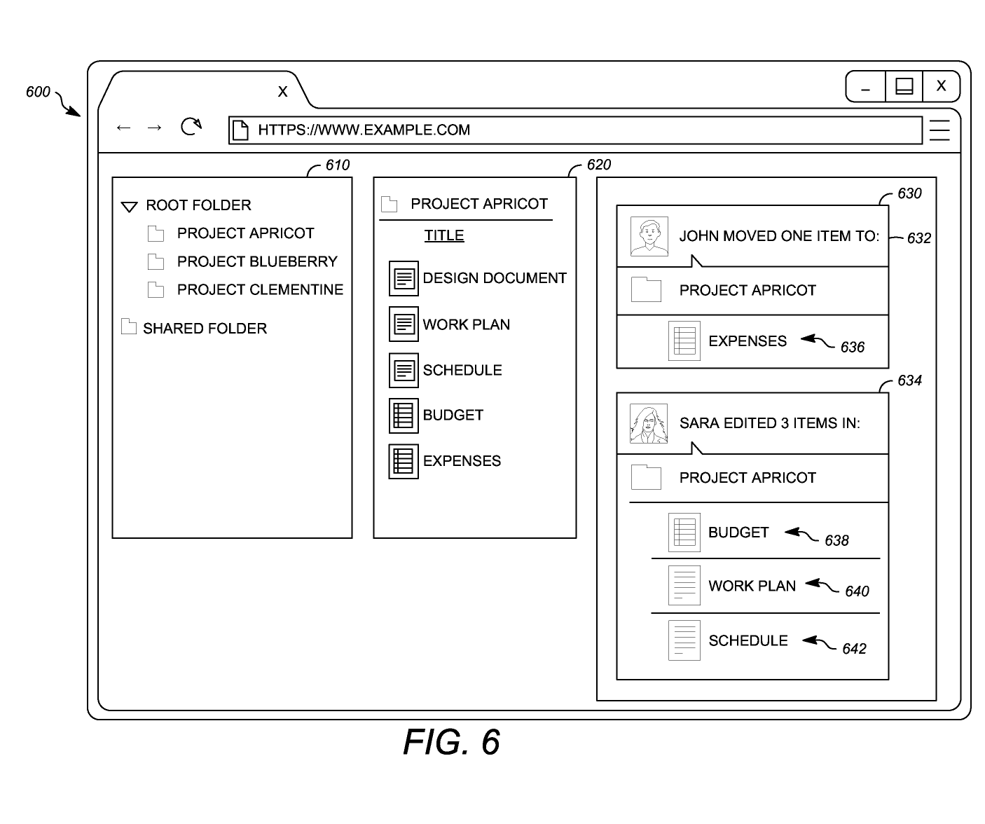

An example of generation of an activity stream will be explained with reference to FIG. 6, which shows an example of an interface screen 600 for the storage system 330. The interface screen 600 can, in some implementations be displayed in the context of a web browser by way of a web page that is encoded in a mark-up language such as HTML that is transmitted from the application hosting service 130 to the user system 110 and output for display at the user system 110. In other examples, the interface screen 600 can be presented in a different type of application, such as a standalone application.

The storage system 330 can implement storage of objects, such as documents, images or other files. Objects can be stored in locations, which can be hierarchical or non-hierarchical folders or collections. Locations can include other types of storage organization methods could be implemented. The interface screen 600 can include a navigation area 610 showing locations such as folders and/or attribute-based collections of documents (recent items, favorite items, etc.) that are accessible to a user to whom the interface screen 600 is output for display. The interface screen 600 can also include an object area 620 where the contents or members of a folder or collection are displayed. In the illustrated example, the object area is in the form of a list of objects that are located in a folder that is titled “Project Apricot.” The interface screen can, in some implementations, include one or more user interface elements that allow the user to perform actions with respect to one or more of the objects that are represented in the object area 620. Examples of actions that can be performed with respect to objects include viewing, opening, moving, and deleting objects. In some implementations, additional information can be displayed in the object area 620. The additional information can include, for example, an identity of an owner of each object, and a time of creation and/or modification of each object.

The interface screen 600 also includes an activity stream 630 according to a first example. The activity stream 630 includes a filtered set of activity information items, where the filtering metric is location having a value corresponding to the “Project Apricot” folder. Thus, the activity stream 630 is generated based on activity information items that relate to the “Project Apricot” folder, such as activity information items describing actions taken with respect to items that are located in the folder. In this example, the filtering metric is identified based on context, in that it is displayed alongside the object area 620 representing the “Project Apricot” folder. For example, this activity stream could be initially displayed when the user navigates to the folder in the interface 600. The activity stream 630 is also generated based on a grouping metric, which in this case in user identity, and thus the activity stream 630 includes a first group 632 and a second group 634. The first group 632 includes information based on activity information items associated with a user identified as “John.” A display item 636 in the first group 634 corresponds to an activity information item reflecting movement of an object identified as “Expenses” to the “Project Apricot” folder. A second group 634 includes information based on activity information items associated with a user identified as “Sara.” A first display item 638, a second display item 640, and a third display item 642 in the second group 634 represent three separate activity information items that each correspond to an edit action taken by Sara with respect to a different object in the “Project Apricot” folder.

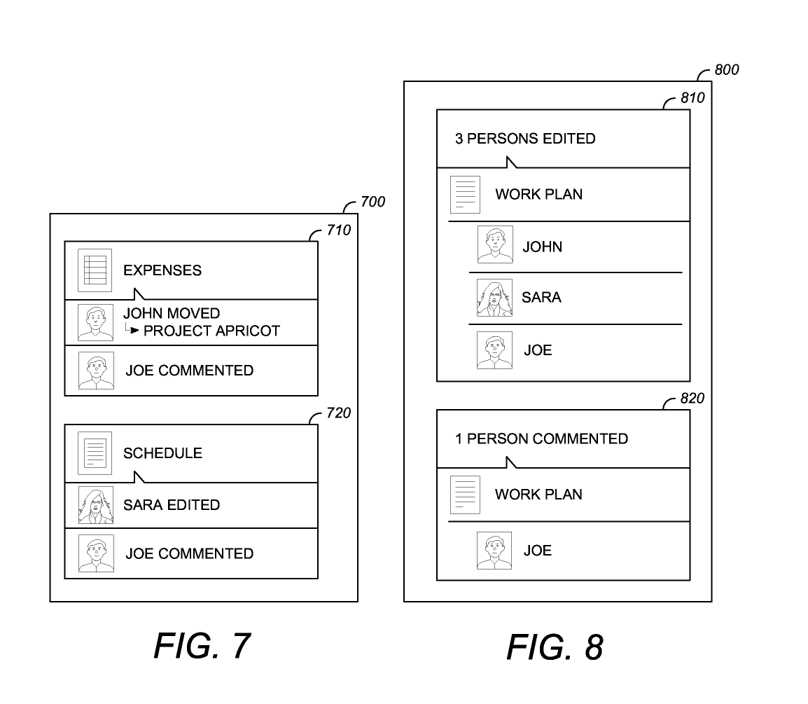

FIG. 7 is an illustration showing an activity stream 700 according to a second example. The activity stream 700 includes a filtered set of activity information items, where the filtering metric is location having a value corresponding to a container object, which in this example is the “Project Apricot” folder. Thus, the activity stream 700 is generated based on activity information items that relate to the “Project Apricot” folder. A first group 710 and a second group 720 are represented in the activity stream 700, generated based on file identity as a grouping metric, where the first group 710 includes display items relating to actions taken with respect to the “Expenses” object and the second group 720 includes display items relating to actions taken with respect to the “Schedule” object. As an example, the activity stream 700 could be generated within the interface 600 in place of the activity stream 630 responsive to user selection of an interface element representing the “Project Apricot” folder.

FIG. 8 is an illustration showing an activity stream 800 according to a third example. The activity stream 800 includes a filtered set of activity information items, where the filtering metric is object identity having a value corresponding to the “Work Plan” object. As an example, the activity stream 800 could be generated within the interface 600 in place of the activity stream 630 responsive to user selection of an interface element, namely the representation of the “Work Plan” object in the object area 620. A first group 810 and a second group 820 are represented in the activity stream 800, generated based on event type as a grouping metric, where the first group 810 includes display items relating to actions of the “edit” type and the second group 820 corresponds to actions of the “comment” type.

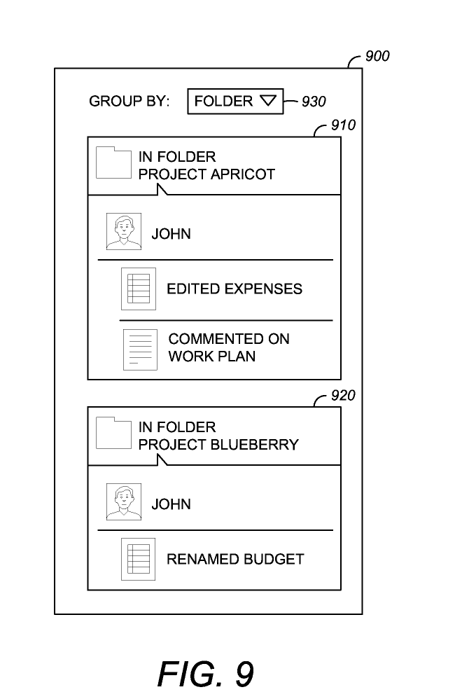

FIG. 9 is an illustration showing an activity stream 900 according to a fourth example. The activity stream 900 includes a filtered set of activity information items, where the filtering metric is user identity having a value corresponding to the user identified as “John.” A first group 910 and a second group 920 are represented in the activity stream 900, generated based on location as a grouping metric, where the first group 910 includes display items relating to objects in the “Project Apricot” folder and the second group 920 includes display items relating to objects in the “Project Blueberry” folder. The activity stream 900 includes a user-operable interface control 930 in the form of a drop down box that can be used to select the grouping metric. For example, the contents of the activity stream 900 could be reorganized by regrouping in response to user selection of a different grouping metric using the interface control 930.

The foregoing description describes only some exemplary implementations of the described techniques. Other implementations are available. For example, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such.

The implementations of the computer devices (e.g., clients and servers) described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of each of the clients and each of the servers described herein do not necessarily have to be implemented in the same manner.

Operations that are described as being performed by a single processor, computer, or device can be distributed across a number of different processors, computers or devices. Similarly, operations that are described as being performed by different processors, computers, or devices can, in some cases, be performed by a single processor, computer or device.

Although features may be described above or claimed as acting in certain combinations, one or more features of a combination can in some cases be excised from the combination, and the combination may be directed to a sub-combination or variation of a sub-combination.

The systems described herein, such as client computers and server computers, can be implemented using general purpose computers/processors with a computer program that, when executed, carries out any of the respective methods, algorithms and/or instructions described herein. In addition or alternatively, for example, special purpose computers/processors can be utilized which can contain specialized hardware for carrying out any of the methods, algorithms, or instructions described herein.

Some portions of above description include disclosure presented in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality. It should be noted that the process steps and instructions of implementations of this disclosure could be embodied in software, firmware or hardware, and when embodied in software, could be downloaded to reside on and be operated from different platforms used by real time network operating systems.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

At least one implementation of this disclosure relates to an apparatus for performing the operations herein. This apparatus may be specially constructed for the required purposes, or it may comprise a general-purpose computer selectively activated or reconfigured by a computer program stored on a computer readable storage medium that can be accessed by the computer.

All or a portion of the embodiments of the disclosure can take the form of a computer program product accessible from, for example, a non-transitory computer-usable or computer-readable medium. The computer program, when executed, can carry out any of the respective techniques, algorithms and/or instructions described herein. A non-transitory computer-usable or computer-readable medium can be any device that can, for example, tangibly contain, store, communicate, or transport the program for use by or in connection with any processor. The non-transitory medium can be, for example, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for tangibly containing, storing, communicating, or transporting electronic instructions.

It is to be understood that the disclosure is not to be limited to the disclosed embodiments but, on the contrary, is intended to cover various modifications and equivalent arrangements included within the spirit and scope of the appended claims.

What is claimed is:

1. A method, comprising:
storing, at one or more computing devices, a plurality of activity information items, each activity information item describing an action taken with respect to a respective object from a plurality of objects that are stored at a shared access system, and each activity information item including a plurality of parameter values each corresponding to one of a plurality of parameter types;
identifying a filtering metric, wherein the filtering metric corresponds to a specified value for a first parameter type from the plurality of parameter types;
generating a filtered set of activity information items that match the specified value for the first parameter type;
identifying a grouping metric, wherein the grouping metric corresponds to a second parameter type from the plurality of parameter types;
identifying one or more groups of activity information items from the filtered set of activity information items, wherein each group from the one or more groups corresponds to a unique parameter value for the second parameter type; and
outputting, for display, an activity stream including information that represents each activity information item from the filtered set of activity information items arranged according to the one or more groups.

2. The method of claim 1, wherein the plurality of parameter types include at least one of an object identity parameter type, a user identity parameter type, an object location parameter type, an object class parameter type, an action class parameter type, or an application identity parameter type.

3. The method of claim 1, wherein the filtering metric is identified based on a default value.

4. The method of claim 1, wherein the filtering metric is identified based on an input signal received from a user.

5. The method of claim 1, further comprising:
outputting, for display, a current view including representations of currently displayed objects from the plurality of objects.

6. The method of claim 5, wherein the specified value for the filtering metric corresponds to a current location that is represented by the current view.

7. The method of claim 5, further comprising:
receiving an input signal identifying one of currently displayed objects from the current view, wherein the specified value for the filtering metric corresponds to at least one parameter value for the object identified by the input signal.

8. The method of claim 1, wherein the grouping metric is identified based on at least one of a default value, an input signal received from a user, or information associated with a current view.

9. The method of claim 1, wherein the grouping metric is identified based on an input signal received via a user-operable input control that is output for display with the activity stream.

10. A non-transitory computer-readable storage device including program instructions executable by one or more processors that, when executed, cause the one or more processors to perform operations, the operations comprising:
storing a plurality of activity information items, each activity information item describing an action taken with respect to a respective object from a plurality of objects that are stored at a shared access system, and each activity information item including a plurality of parameter values each corresponding to one of a plurality of parameter types;
identifying a filtering metric, wherein the filtering metric corresponds to a specified value for a first parameter type from the plurality of parameter types;
generating a filtered set of activity information items that match the specified value for the first parameter type;
identifying a grouping metric, wherein the grouping metric corresponds to a second parameter type from the plurality of parameter types;
identifying one or more groups of activity information items from the filtered set of activity information items, wherein each group from the one or more groups corresponds to a unique parameter value for the second parameter type; and
outputting, for display, an activity stream including information that represents each activity information item from the filtered set of activity information items arranged according to the one or more groups.

11. The non-transitory computer-readable storage device of claim 10, wherein the plurality of parameter types include at least one of an object identity parameter type, a user identity parameter type, an object location parameter type, an object class parameter type, an action class parameter type, or an application identity parameter type.

12. The non-transitory computer-readable storage device of claim 10, wherein the filtering metric is identified based on a default value.

13. The non-transitory computer-readable storage device of claim 10, wherein the filtering metric is identified based on an input signal received from a user.

14. The non-transitory computer-readable storage device of claim 10, further comprising:
outputting, for display, a current view including representations of currently displayed objects from the plurality of objects.

15. The non-transitory computer-readable storage device of claim 14, wherein the specified value for the filtering metric corresponds to a current location that is represented by the current view.

16. The non-transitory computer-readable storage device of claim 14, further comprising:
receiving an input signal identifying one of currently displayed objects from the current view, wherein the specified value for the filtering metric corresponds to at least one parameter value for the object identified by the input signal.

17. The non-transitory computer-readable storage device of claim 10, wherein the grouping metric is identified based on at least one of a default value, an input signal received from a user, or information associated with a current view.

18. The non-transitory computer-readable storage device of claim 10, wherein the grouping metric is identified based on an input signal received via a user-operable input control that is output for display with the activity stream.

19. An apparatus, comprising:
one or more processors; and
one or more memory devices for storing program instructions used by the one or more processors, wherein the program instructions, when executed by the one or more processors, cause the one or more processors to:
store a plurality of activity information items, each activity information item describing an action taken with respect to a respective object from a plurality of objects that are stored at a shared access system, and each activity information item including a plurality of parameter values each corresponding to one of a plurality of parameter types;
identify a filtering metric, wherein the filtering metric corresponds to a specified value for a first parameter type from the plurality of parameter types;
generate a filtered set of activity information items that match the specified value for the first parameter type;
identify a grouping metric, wherein the grouping metric corresponds to a second parameter type from the plurality of parameter types;
identify one or more groups of activity information items from the filtered set of activity information items, wherein each group from the one or more groups corresponds to a unique parameter value for the second parameter type; and
output, for display, an activity stream including information that represents each activity information item from the filtered set of activity information items arranged according to the one or more groups.

20. The apparatus of claim 19, wherein the plurality of parameter types include at least one of an object identity parameter type, a user identity parameter type, an object location parameter type, an object class parameter type, an action class parameter type, or an application identity parameter, the filtering metric is identified based on at least one of a default value, an input signal received from a user, or information associated with a current view, and the grouping metric is identified based on at least one of a default value, an input signal received from a user, or information associated with a current view.
